(19) United States
(12) Patent Application Publication
(10) Pub. No.: US 2016/0046006 A1
(43) Pub. Date: Feb. 18, 2016

(54) ADJUSTMENT TOOL OF SPRING PRELOADED ADJUSTMENT RING

(71) Applicant: Jen-Yung YANG, Taichung City (TW)

(72) Inventor: Jen-Yung YANG, Taichung City (TW)

(21) Appl. No.: 14/485,661

(22) Filed: Sep. 12, 2014

(30) Foreign Application Priority Data
Aug. 13, 2014 (TW) 103214426

(51) Int. Cl. B25B 23/00; B25B 13/50; B25B 13/48; B25B 13/56; B25B 13/28

(52) U.S. Cl. CPC B25B 23/0028; B25B 13/56; B25B 13/28; B25B 13/481; B25B 13/50

(57) ABSTRACT

An adjustment tool of spring preloaded adjustment ring includes a handle for manual holding and operation and an extension section for fitting on the circumference of the spring preloaded adjustment ring. The working angle contained between the extension section and the handle is adjustable. Accordingly, an operator can change the working angle to successfully operate the adjustment tool in a narrow space.

### BACKGROUND OF THE INVENTION

1. Field of the Invention

The present invention relates generally to a vehicle service tool, and more particularly to an adjustment tool of spring preloaded adjustment ring.

2. Description of the Related Art

In a conventional vehicle suspension system, the damping of the shock-absorber or the maximum extension of the spring is adjustable in accordance with a user's requirement so as to provide different suspension and cushioning effects. Various adjustable shock-absorbers and exclusive adjustment tools are commercially available.

FIG. 1 shows a conventional adjustment tool 1 of adjustable shock-absorber. In structure, such adjustment tool 1 generally has a handle 2 with a certain length for manual holding and operation. An extension arm 3 with a certain length and radian is fixedly disposed at one end of the handle. Two spaced claw protrusions 4 are respectively disposed at two ends of the extension arm 3. In use of the adjustment tool 1, the extension arm 3 is positioned in adjacency to one side of the preloaded adjustment ring 6 of the shock-absorber 5 with the claw protrusions 4 engaged in the latch holes preformed on the preloaded adjustment ring 6. Accordingly, the adjustment tool 1 is latched with the preloaded adjustment ring 6. Under such circumstance, an operator can hold the handle 2 to rotate the adjustment tool 1 so as to rotate the preloaded adjustment ring 6 around the cylindrical body of the shock-absorber 5. In this case, the maximum extension of the spring 7 can be changed.

With respect to the adjustment of the conventional adjustment tool 1 to the shock-absorber, in the case that the shock-absorber 5 is not yet installed on the vehicle, the adjustment tool 1 can be easily operated to adjust the maximum extension of the spring 7. However, in the case that the adjustment tool 1 is used to adjust the shock-absorber 5′ installed in the vehicle as shown in FIG. 2, it will be hard to operate the adjustment tool 1. This is because the shock-absorber 5′ is positioned in a very narrow space in which the adjustment tool 1 can be hardly easily operated. The shock-absorber of the vehicle suspension system is positioned between the wheel system of the vehicle in contact with the ground and the body of the vehicle so as to cushion and absorb the shock to the vehicle when running on the ground. Therefore, no matter which kind of suspension system is employed, the shock-absorber is positioned where the wheel is positioned and installed in a very narrow space. Therefore, when using the adjustment tool 1 to adjust the shock-absorber, it is hard to operate the adjustment tool 1 in the limited space. The conventional adjustment tool 1 lacks any design fro an operator to overcome the problem of narrow space so that it is hard for the operator to easily operate the adjustment tool 1 in the narrow space.

### SUMMARY OF THE INVENTION

It is therefore a primary object of the present invention to provide an adjustment tool of spring preloaded adjustment ring. An operator can operate the adjustment tool in a narrow operation space to adjust the spring preloaded adjustment ring so as to adjust the maximum extension of the spring.

To achieve the above and other objects, the adjustment tool of spring preloaded adjustment ring of the present invention includes a handle for manual holding and operation and an extension section for fitting on the circumference of the spring preloaded adjustment ring. The working angle contained between the extension section and the handle is adjustable. Accordingly, an operator can change the working angle to successfully operate the adjustment tool in a narrow space.

The adjustment tool of spring preloaded adjustment ring of the present invention includes: a handle; an extension section pivotally connected with the handle via a pivot pin, the extension section being rotatable around the pivot pin to change the position of the extension section relative to the handle, the extension section having an engagement protrusion distal from the pivot pin; and a first engagement section and a second engagement section respectively disposed on the handle and the extension section, the first and second engagement section being engageable with each other to locate the extension section and the handle with each other so as to maintain the relative position between the extension section and the handle.

The first and second engagement sections mainly serve to locate the working angle contained between the handle and the extension section after adjusted. Therefore, the first and second engagement sections can be any structure that is able to engage the handle with the extension section and locate the working angle contained between the handle and the extension section. In practice, the first and second engagement sections can be pawl and ratchets engageable with each other or multiple locating holes and locating pins inserted in the locating holes.

In the above adjustment tool, the ratchets can have symmetrical or asymmetrical tooth forms.

In the above adjustment tool, the pawl is pivotally connected with the handle for engaging with the corresponding ratchets.

In the above adjustment tool, the first engagement section has the pawl and an elastic body. The elastic body serves to provide elastic force for keeping the pawl elastically engaged with the corresponding ratchets.

In the above adjustment tool, the extension section further has an arm. One end of the arm is pivotally connected with the handle.

In order to adapt the arm of the adjustment tool to the circular configuration of the spring preloaded adjustment ring, the arm has an arched configuration for snugly attaching to the outer circumference of the spring preloaded adjustment ring. Accordingly, the arm can be smoothly engaged with the spring preloaded adjustment ring.

In order to apply the adjustment tool of the spring preloaded adjustment ring to different spring preloaded adjustment rings with different outer diameters, the arm further includes a front end piece. One end of the front end piece is pivotally connected with the handle via a pivot pin. The arm further includes a rear end piece. One end of the rear end piece is pivotally connected with the other end of the front end piece via a pivot pin. Accordingly, the rear end piece is pivotally connected with the front end piece so that the configuration of the arm is changeable and the adjustment tool is applicable to a spring preloaded adjustment ring with different outer diameter.

In order to further enlarge the range of outer diameter of the spring preloaded adjustment ring to which the adjustment tool is applicable, the pivot pin between the extension section and the handle and the pivot pin between the front end piece and the rear end piece are both detachable. In this case, the front end piece or the rear end piece can be replaced with another one to further enlarge the application range of the adjustment tool of the spring preloaded adjustment ring.

The present invention can be best understood through the following description and accompanying drawings, wherein:

### BRIEF DESCRIPTION OF THE DRAWINGS

FIG. 1 is a perspective view showing the use of a conventional adjustment tool for spring preloaded adjustment ring;

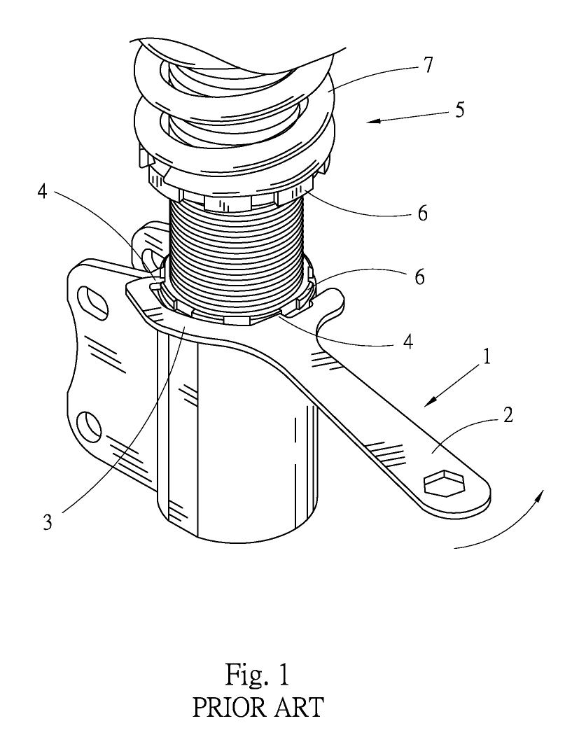

FIG. 2 is a view showing that the shock-absorber is installed in a narrow space of a vehicle;

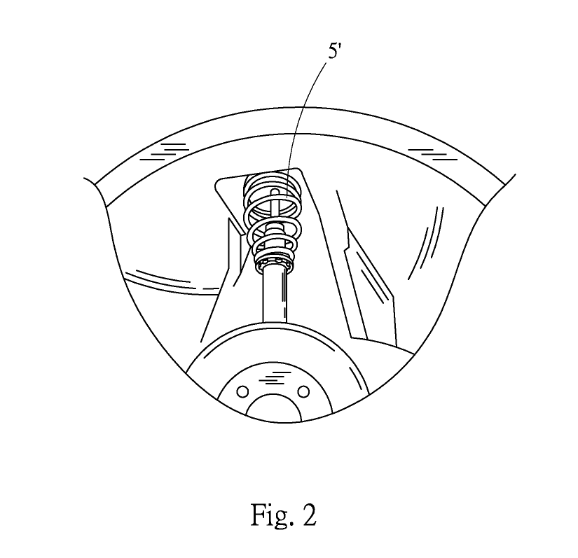

FIG. 3 is a perspective exploded view of a preferred embodiment of the present invention;

FIG. 4 is a perspective assembled view of the preferred embodiment of the present invention;

FIG. 5 is a sectional view taken along line a-a of FIG. 4, showing that the adjustment tool is used with a first working angle contained between the handle and the extension section;

FIG. 6 is a sectional view taken along line a-a of FIG. 4, showing that the angle contained between the handle and the extension section is changed from the first working angle to a second working angle;

FIG. 7 is a sectional view taken along line a-a of FIG. 4, showing that the adjustment tool is used with the second working angle contained between the handle and the extension section;

FIG. 8 is a sectional view taken along line a-a of FIG. 4, showing that the angle contained between the handle and the extension section is changed from the second working angle to the first working angle; and

FIG. 9 is a sectional view taken along line a-a of FIG. 4, showing that the adjustment tool is applied to a spring preloaded adjustment ring with a different outer diameter.

### DETAILED DESCRIPTION OF THE PREFERRED EMBODIMENTS

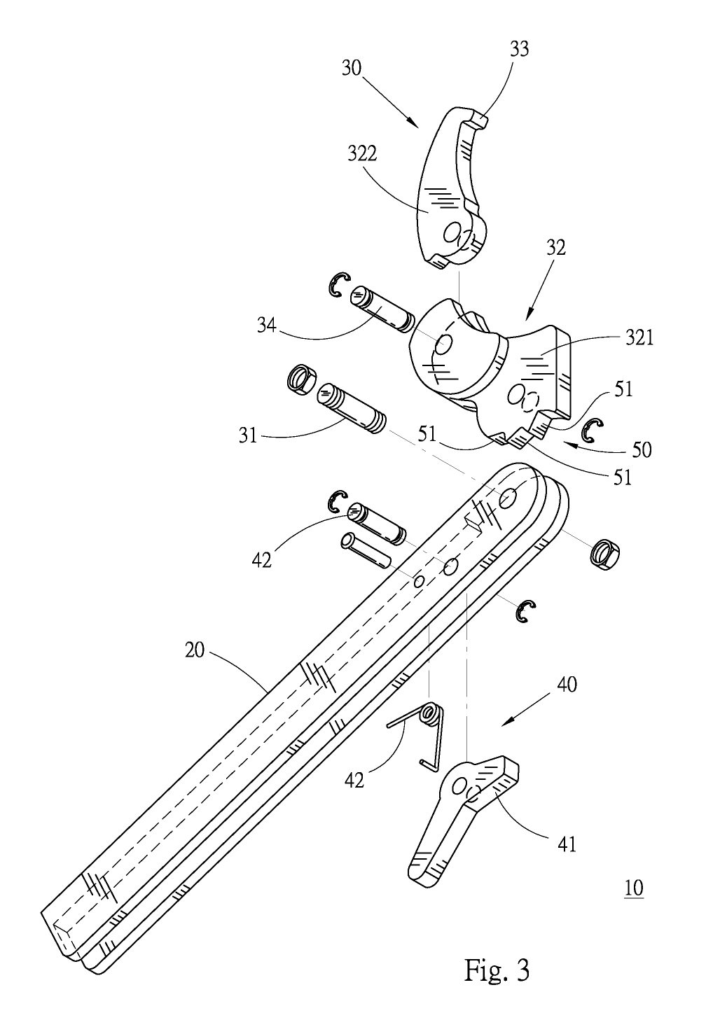

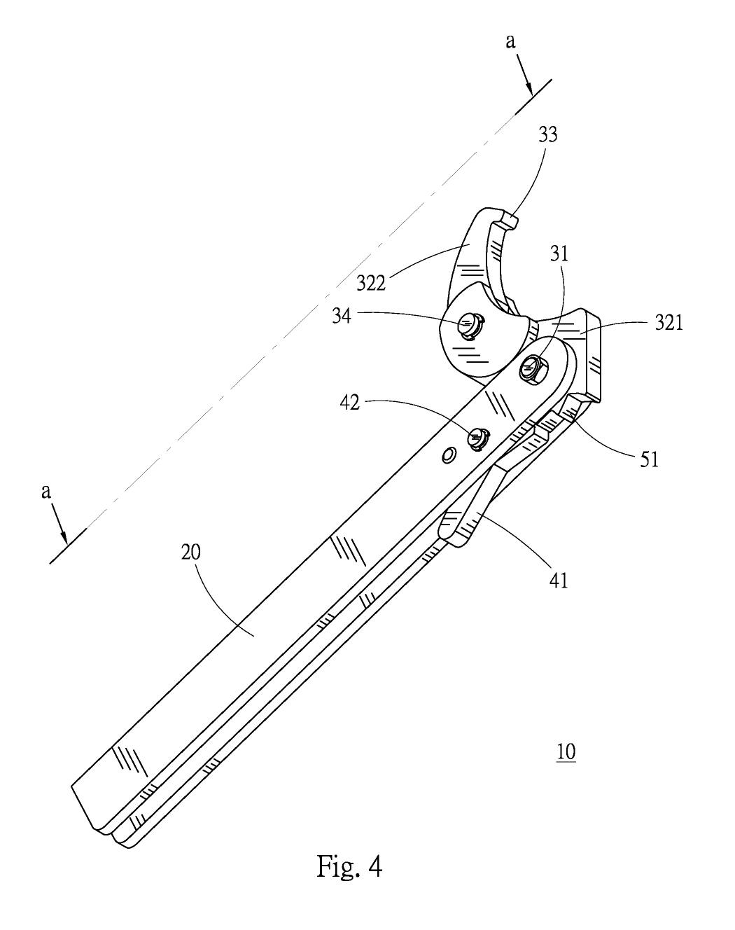

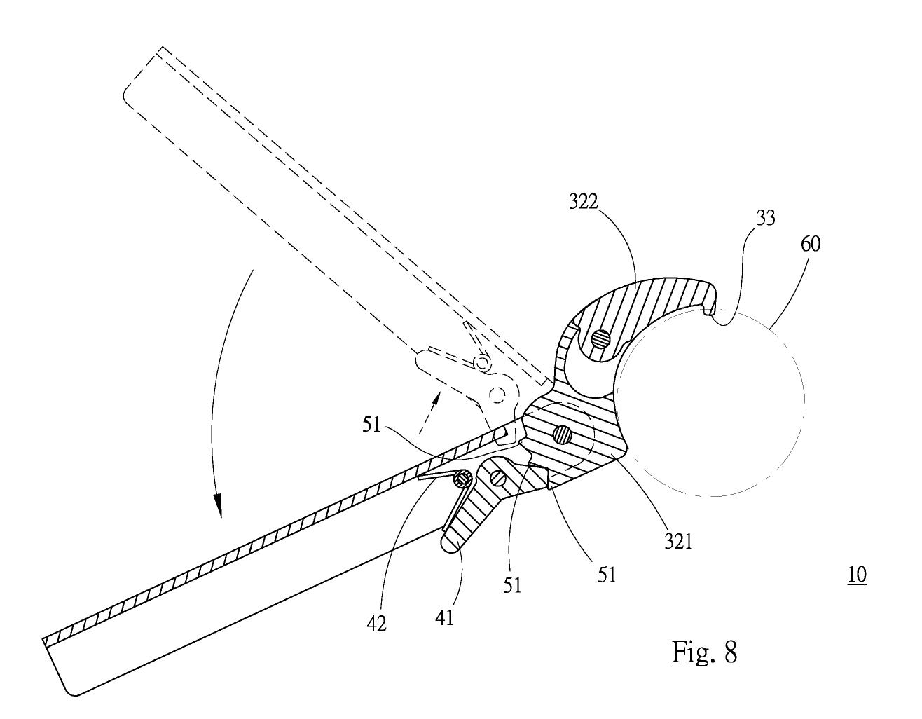

Please refer to FIGS. 3 to 9. According to a preferred embodiment, the adjustment tool 10 of spring preloaded adjustment ring of the present invention includes a handle 20, an extension section 30, a first engagement section 40 and a second engagement section 50.

The handle 20 is an elongated straight bar body with a certain length. The handle 20 has a configuration suitable for manual holding. In addition, the handle 20 has a structural strength capable of bearing manual wrenching force.

The extension section 30 is pivotally connected with one end of the handle 20 via a first pivot pin 31. The extension section 30 is rotatable around the first pivot pin 31 to change the angle contained between the extension section 30 and the handle 20. To speak more specifically, the extension section 30 has an arm 32 with a certain length. One end of the arm 32 is pivotally connected with the handle 20 via the first pivot pin 31. An engagement protrusion 33 is formed on the other end of the arm 32.

Accordingly, in use of the adjustment tool 10, in similarity to the conventional use manner, the arm 32 is positioned in adjacency to outer circumference of the spring preloaded adjustment ring 60 and the engagement protrusion 33 is engaged in an engagement socket (not shown) of the spring preloaded adjustment ring 60. Under such circumstance, the extension section 30 is engaged with the spring preloaded adjustment ring 60. At this time, an operator can hold the handle 20 to forcedly rotate the spring preloaded adjustment ring 60 so as to adjust the preloaded state of the maximum extension of the shock-absorber spring.

In order to adapt the adjustment tool 10 to the circular configuration of the spring preloaded adjustment ring 60, the arm 32 has an arched configuration for snugly attaching to the circumference of the spring preloaded adjustment ring 60.

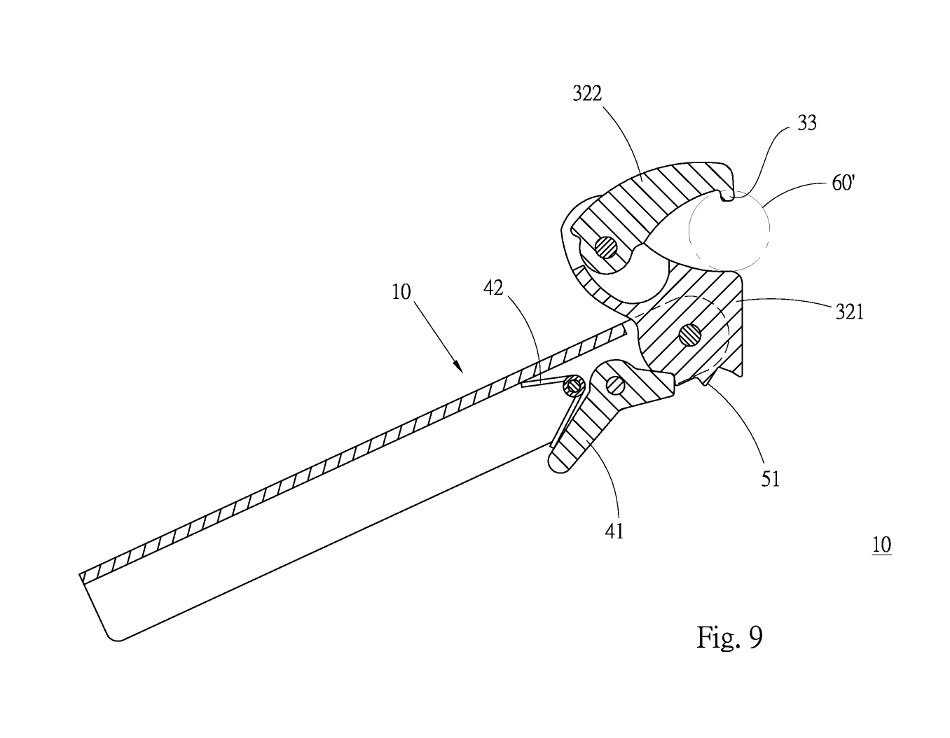

Moreover, in order to apply the arm 32 to different spring preloaded adjustment rings with different outer diameters, the arm 32 further includes a front end piece 321. One end of the front end piece 321 is pivotally connected with the handle 20 via the first pivot pin 31. The arm 32 further includes a rear end piece 322. One end of the rear end piece 322 is pivotally connected with the other end of the front end piece 321 via a second pivot pin 34. The engagement protrusion 33 is formed on the other end of the rear end piece 322. Accordingly, as shown in FIG. 9, when the adjustment tool 10 is applied to a spring preloaded adjustment ring 60′ with smaller outer diameter, the rear end piece 322 is rotated relative to the front end piece 321 to make the engagement protrusion 33 engaged in the engagement socket (not shown) of the spring preloaded adjustment ring 60′. Accordingly, the adjustment tool 10 is applicable to different spring preloaded adjustment rings with different outer diameters.

Also, in order to further enlarge the application size range of the adjustment tool 10, the first and second pivot pins 31, 34 are both detachable. In this case, the front end piece 321 or the rear end piece 322 can be replaced with another one with different radians or arc lengths in accordance with actual use requirement. Accordingly, the adjustment tool 10 is applicable to a larger size range.

The first and second engagement sections 40, 50 are respectively disposed on the handle 20 and the extension section 30 and can be engaged with each other so as to locate the relative position between the handle 20 and the extension section 30. Accordingly, the angle contained between the handle 20 and the extension section 30 can be maintained.

The first engagement section 40 has a substantially V-shaped pawl 41. A middle section of the first engagement section 40 is pivotally connected in one end of the handle 20 via a third pivot pin 42. An elastic body 43, which is a torque spring, is disposed in one end of the handle 20. One end of the elastic body 43 abuts against the pawl 41 to apply an elastic force to keep the pawl 41 elastically positioned in a checking position.

The second engagement section 50 has multiple ratchets 51 with asymmetrical tooth forms. The ratchets 51 are disposed on one end of the arm 32, which end is pivotally connected with the handle 20 and correspondingly engaged with the pawl 41 in the checking position.

Accordingly, the pawl 41 of the first engagement section 40 is engaged with the corresponding ratchets 51 of the second engagement section 50 so that the extension section 30 is locked with the handle 20 to maintain the angle contained therebetween.

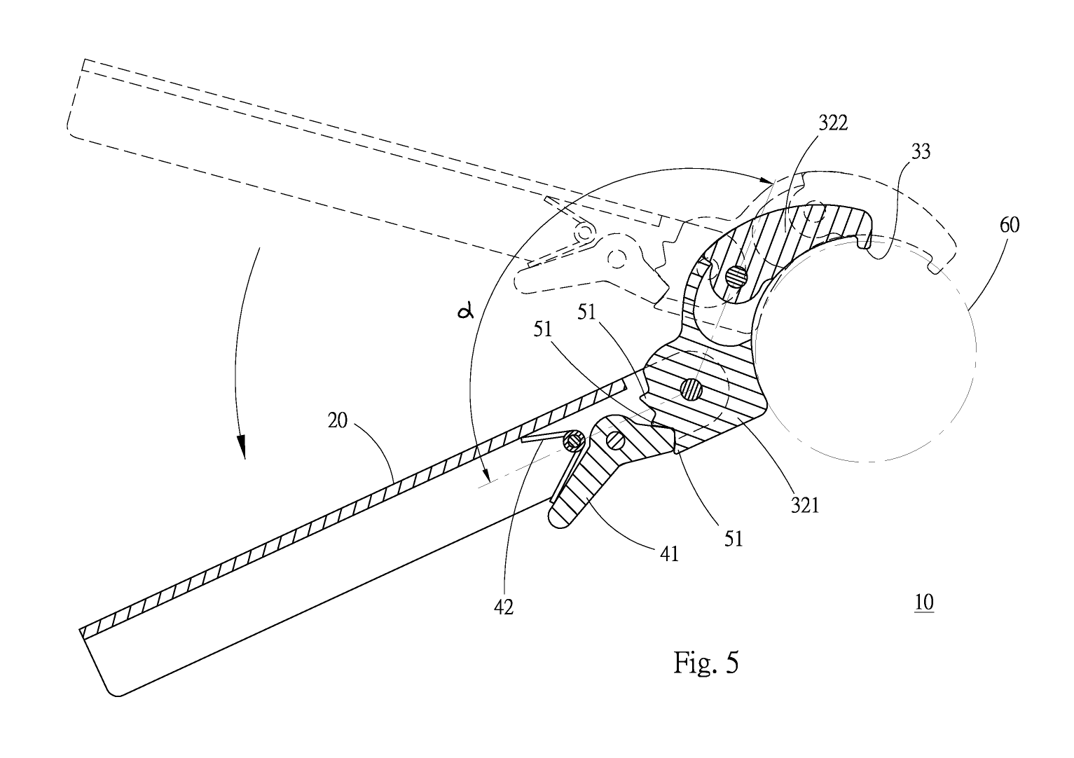

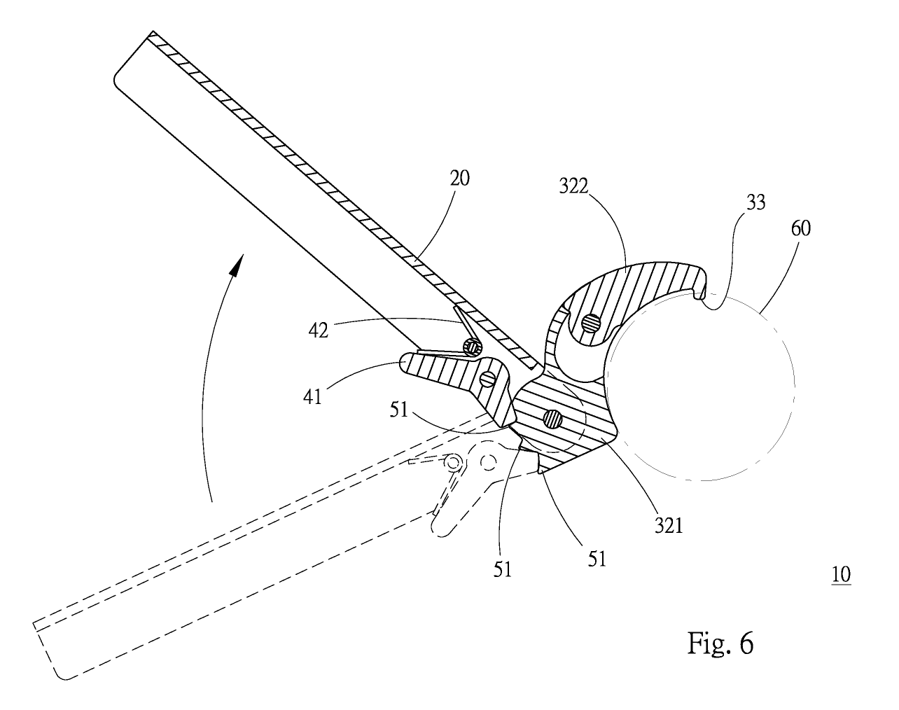

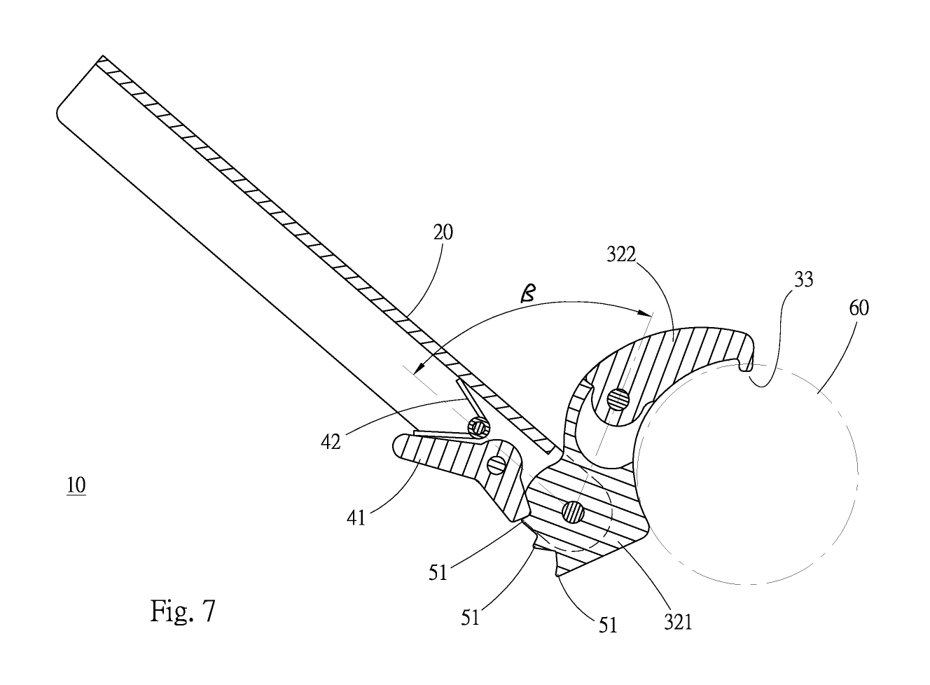

According to the above arrangement, in use of the adjustment tool 10 of the spring preloaded adjustment ring, a first working angle α is contained between the extension section 30 and the handle 20 as shown in FIG. 5 and the extension section 30 is properly engaged with the spring preloaded adjustment ring 60. At this time, an operator can hold the handle 20 to manually wrench the spring preloaded adjustment ring 60 to clockwise or counterclockwise rotate in accordance with the actual adjustment requirement. After the first rotation, the engagement between the extension section 30 and the spring preloaded adjustment ring 60 is maintained as shown in FIG. 6. Then, the handle 20 is rotated around the first pivot pin 31 in a direction reverse to the first rotation so as to change the angle contained between the extension section 30 and the handle 20 to a smaller second working angle β as shown in FIG. 7. Then, the operator can hold the handle 20 to perform a second rotation. Accordingly, the operator can hold the handle 20 to perform at least two times of wrenching operation in a narrow operation space. Therefore, the space can be fully utilized to overcome the shortcoming of the conventional technique.

The above embodiments are only used to illustrate the present invention, not intended to limit the scope thereof. Many modifications of the above embodiments can be made without departing from the spirit of the present invention.

1-10. (canceled)

11. An adjustment tool of spring preloaded adjustment ring, comprising:
a handle;
an extension section pivotally connected with the handle via a pivot pin, the extension section being rotatable around the pivot pin to change the position of the extension section relative to the handle, the extension section having an engagement protrusion distal from the pivot pin; and
a first engagement section and a second engagement section respectively disposed on the handle and the extension section, the first and second engagement section being engageable with each other to locate the extension section and the handle with each other so as to maintain the relative position between the extension section and the handle.

12. The adjustment tool of spring preloaded adjustment ring as claimed in claim 11, wherein the first engagement section has a pawl and the second engagement section has multiple ratchets engageable with the pawl.

13. The adjustment tool of spring preloaded adjustment ring as claimed in claim 12, wherein the ratchets have asymmetrical tooth forms.

14. The adjustment tool of spring preloaded adjustment ring as claimed in claim 12, wherein the ratchets are formed on one end of the extension section in adjacency to the pivot pin, the pawl being pivotally connected with the handle, the end of the pawl being engaged with the corresponding ratchets.

15. The adjustment tool of spring preloaded adjustment ring as claimed in claim 13, wherein the ratchets are formed on one end of the extension section in adjacency to the pivot pin, the pawl being pivotally connected with the handle, the end of the pawl being engaged with the corresponding ratchets.

16. The adjustment tool of spring preloaded adjustment ring as claimed in claim 12, wherein the first engagement section further includes an elastic body, the elastic body serving to provide elastic force for making the pawl elastically engaged with the corresponding ratchets.

17. The adjustment tool of spring preloaded adjustment ring as claimed in claim 13, wherein the first engagement section further includes an elastic body, the elastic body serving to provide elastic force for making the pawl elastically engaged with the corresponding ratchets.

18. The adjustment tool of spring preloaded adjustment ring as claimed in claim 11, wherein the extension section further includes an arm, one end of the arm being pivotally connected with the handle.

19. The adjustment tool of spring preloaded adjustment ring as claimed in claim 18, wherein the arm has front end piece and a rear end piece, one end of the front end piece being pivotally connected with the handle, one end of the rear end piece being pivotally connected with the other end of the front end piece.

20. The adjustment tool of spring preloaded adjustment ring as claimed in claim 19, wherein the arm further includes two lugs protruding from the other end of the front end piece in parallel to each other, the two lugs being positioned on two sides of one end of the rear end piece and pivotally connected with the rear end piece.

21. The adjustment tool of spring preloaded adjustment ring as claimed in claim 19, wherein the engagement protrusion is formed on the other end of the rear end piece.

22. The adjustment tool of spring preloaded adjustment ring as claimed in claim 16, wherein the arm has an arched configuration.

23. The adjustment tool of spring preloaded adjustment ring as claimed in claim 17, wherein the arm has an arched configuration.
